(19) United States
(12) Patent Application Publication
(10) Pub. No.: US 2014/0025611 A1
(43) Pub. Date: Jan. 23, 2014

(54) Knowledge based platform and associated methods to identify and aid in decision making skills of human being by mapping selection of products or services to underlying reasoning parameters.Underlying parameters are determined by domain experts based on domain of product or service in which user submitted his selection without providing any additional parameters

(71) Applicant: Debi Prasad Sahoo, San Jose, CA (US)

(72) Inventor: Debi Prasad Sahoo, San Jose, CA (US)

(21) Appl. No.: 13/938,902

(22) Filed: Jul. 10, 2013

Related U.S. Application Data
(60) Provisional application No. 61/670,229, filed on Jul. 11, 2012.

(51) Int. Cl. G06N 5/02

(52) U.S. Cl. CPC G06N 5/02
USPC 706/14; 706/45; 706/58; 706/46

(57) ABSTRACT

A knowledge based platform and associated methods to identify and aid in decision making skills of human being by mapping selection of products or services to underlying reasoning parameters. Underlying parameters being determined by domain experts based on domain of product or service in which user submitted his selection without providing any additional parameters.

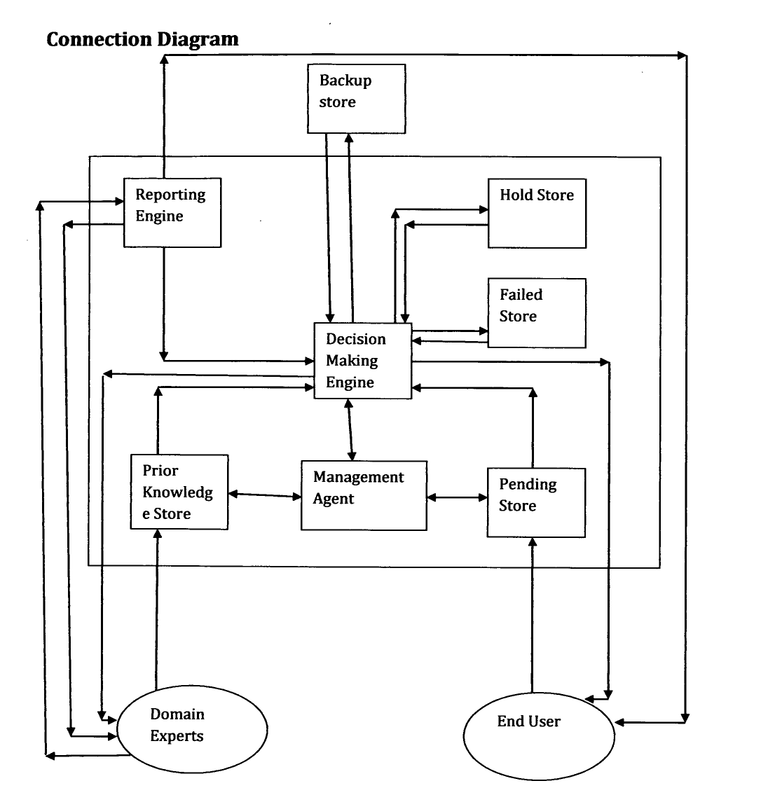

### FIELD OF INVENTION

Artificial Intelligence

### SPECIFICATION

Each individual possess special skills which may not be known to him but if it can explored it would help him in his decision making process. The idea is to have a knowledge based system which will try to achieve this task.

Proposed platform helps in creating a knowledge base based on user supplied selection item whether it is a product or a service if it passes key parameters identified by domain experts using the method proposed in this application.

The proposed knowledge base is subsequently used to confirm as a successful selection to subsequent requests with the user input, which has already been validated to pass the method of successful selection. If it was earlier rejected user is notified with failure of validation. If selection is not found in reject store it is checked in pending store or hold store and user is notified with decision validation is pending.

### COMPONENTS OF THE PLATFORM

The following components form the basic building block of the proposed platform.

Next section titled “Connection Diagram” depicts the connection between different components of the platform.

### Decision Making Engine

This is the component which takes user provided selection from pending store and decides value associated with the selection and let user know about correctness of the choice based on knowledge already acquired in the system or by querying domain experts of that selection.

Decision making engine does store various data associated with the selection into one of the data stores namely Prior Knowledge Store(PRKS), Hold Knowledge Store(HKS), Pending Knowledge Store(PKS), Backup Knowledge Store(BKS), Failed Knowledge Store(FKS).

Decision making engine helps reporting engine to generate report of knowledge summary based on domain in on a need basis.

Prior Knowledge Store stores selections which have been passed key test based on the method proposed in this application or continuous update of selections from domain experts based on their research of products or services independent of operations of the platform and end user input.

Pending knowledge store keeps list of selections which yet to be analyzed by decision making engine. This is required as system may handle certain number of requests at a time. Even sometimes it requires domain expert intervention if same data not found in prior/hold/failed knowledge store.

Hold Knowledge Store

This stores selection which didn't qualify in first attempt and kept for recomputation in a second attempt after interval of T as identified for domain D associated with selection S.

### Failed Knowledge Store

Selection is transferred to this store if it either fails in first attempt or in the second attempt.

### Reporting Engine

This helps in generating report periodically or on a demand basis with explicit request from domain experts.

Backup Store

This is used to store data stored in prior knowledge store, pending store, hold store, failed store and report generated in past.

End user

End user interacts with the platform by providing selection of a product or service based on his interest and expects platform decision.

Domain Experts

These are the professionals who analyze product and service offerings to determine key parameters, which would be used to validate user selection. They interact with decision making engine, knowledge store.

Management agent

This controls operation of the platform from computational resource management point of view.

It would perform the following task.
(i) management of domain expert
(ii) management of number of requests to be allowed for a customer in a specific domain
(iii) account information for end user.
(iv) resource monitoring,
(v) resource planning

### Method of Operation

When user wants to validate his selection is correct or not he provides that as input to the platform.

User input is checked against prior knowledge store by the decision making engine(DME). if it is found it is given as a success to the user with the assumption prior knowledge store contains the selection as a result of prior analysis made by domain expert based on proposed decision making algorithm.

If we assume there was no prior knowledge about the selection made by user it is supplied as a query to domain experts. Relevant domain expert analyses this product or service selection against domain specific parameter list which plays an important role in deciding the correctness of the selection by following the proposed logic described below.

Domain expert identifies domain corresponding to selection S as D and finds n parameters (P1, P2, . . . ,Pn).Out of these parameters I find parameters can be given weight of deciding factor in decreasing order for parameters P1,P2, . . . ,Pn based on product or service knowledge gained by domain expert.

Assumption is made w1>w2>w3 . . . >wn but there is no restriction it applies in sequence with P1, P2, . . . ,Pn. For simplicity lets take w1,w2, . . . ,wn are weights associated with P1,P2, . . . ,Pn respectively. When user selects something it can be good or it can be bad. From probability theory chance of good or bad is equally possible. So his submission to system has 50% chance of being good if it is submitted with expectation of whether it goes beyond 50% as much as can till 100% when he can get assurance of his selection and we consider them as good candidate data for finding his ability to make good decision. Since weights are assigned in decreasing order first half of n elements will attribute to more than half of probability of good selection. But the matching elements may or may not fall in first half of parameters that would provide a chance of more than 50%. Instead proposal is made to consider any ¾ of the parameters. Assumption made here ¾ of the matching contributes linearly towards positive side of the selection and ¼ of the parameters contribute towards the negativity of the selection. In best case ¾ elements will be form a sequence in decreasing order and ¼ of the elements will form sequence in decreasing order as per complementary logic. Effect of first sequence will take result well above ¾ and effect of later sequence will take negative result well below ¼ which will provide an net result of more than ½. This is proposed as ¾ positive rule and ¼ negative rule. Impact of negativity is less likely as it is selected as key parameter for a good service though weight of impact on the success of the decision has been identified as relatively low in the best case scenario. If it is best case the selection it is put into the prior knowledge store for future reference else if net result is between ½ and ¾ it is kept in the hold store for re-evaluation after interval T based on impact of selected parameters selected for this domain. During re-evaluation if it is found result has fallen below ½ it is put into failed store concluding the selection is not performing well and not used by decision making engine any more. If result goes past ¾ after interval T it is stored in knowledge store with a risk factor of interval T for the associated selection parameters.

If multiple users(U) select item S and m/n>=¾, where m is number of matching parameters from list of n parameters then U number of parameter set is stored in prior knowledge store if there is no match of sequence of parameters found to be set for their selection. This is possible since user selection can happen over different period of time and their selection parameters would have changed during that time. So It is proposed to keep different subset of parameters from parameter list as set by the domain expert during initial analysis as a benchmark to check against them.

The proposed platform and associated method depicts a new way of validating user knowledge against that of domain experts and builds a repository of knowledge of parameter set that impacts success of a product or service selection.

The proposed method is generic and can be applied to multiple field of applications what is termed as domain(D) with a set of parameters selected by domain experts over a period of time.

1. Input to the system takes selection item as a string without asking user any rational behind the selection. Sometimes user may not know the reason because he wants to validate his selection. In this claim medium of validating claim is the system that comprise of the claims [2],[3],[4] , [5], [6], [7] and [8].

2. Proposed platform generates a query to domain experts registered in the system to evaluate the selection if knowledge base can't determine the quality of the selection.

3. Reasoning behind the selection is rated relatively in certain time interval(T) which is determined by the domain or the field the selection belongs to. For each submission if other users submit the same selection reference count for the original submitter is incremented. At end of interval T users get compared based on reference count.

4. ¾'th rule is applied to set of parameters(n) identified by domain experts for a given domain. if user selection satisfies ¾'th or more(m) of these parameters(n) user submission is considered as a success and a good selection. This selection is stored as good candidate data in the proposed knowledge base which is built upon by applying all components and claims stated in this application.

5. Parameter set matched(m) for the user made selection is below ¼'th is not considered as probability of success goes below ½. If it lies between (>=) ¼ and (<) ¾ selection is put into hold knowledge store(HKS) for revaluation after interval T as referred in claim[2].If revaluation comes

6. Parameter set matched for the user made selection is ¾ and above user selection is put into prior knowledge store (PKS)

7. Parameter set matched (m) for user made selection is equal or above(>=)½ and below (<)¾ user selection is put into prior knowledge store with a risk factor of m/n where m is the number matching parameters and n is the total number of parameters set.

8. Parameter set matched (m) for user made selection is below (<) ½ user selection is put into failed knowledge store (FKS)
